(19) United States
(12) Patent Application Publication
(10) Pub. No.: US 2012/0103509 A1
(43) Pub. Date: May 3, 2012

(54) METHOD FOR BONDING MEMBERS

(75) Inventors: JIA-PING WANG, Beijing (CN); RUI XIE, Beijing (CN); KAI-LI JIANG, Beijing (CN); SHOU-SHAN FAN, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 13/093,849

(22) Filed: Apr. 26, 2011

(30) Foreign Application Priority Data
Oct. 29, 2010 (CN) 201010524873.4

(51) Int. Cl. B32B 37/02; B32B 37/14; B32B 37/06; B32B 37/10; B82Y 99/00

(52) U.S. Cl. 156/272.2; 977/742

(57) ABSTRACT

A method for bonding members is provided. First, a first member having a first surface and a second member having a second surface are provided. A carbon nanotube structure is formed and is located between the first member and the second member, and the carbon nanotube structure contacting the first surface and the second surface. Then the carbon nanotube structure is exposed to electromagnetic waves.

### RELATED APPLICATIONS

This application claims all benefits accruing under 35 U.S.C. §119 from China Patent Application No. 201010524873.4, filed on Oct. 29, 2010 in the China Intellectual Property Office, the disclosure of which is incorporated herein by reference. The application is also related to copending applications entitled, “CARBON NANOTUBE COMPOSITE STRUCTURE”, filed ______ (Atty. Docket No. US36175); “METHOD FOR MAKING CARBON NANOTUBE COMPOSITE STRUCTURE”, filed ______ (Atty. Docket No. US36176).

### BACKGROUND

1. Technical Field

The present disclosure relates to methods for bonding members together, and more particularly, to a method for bonding members together utilizing a carbon nanotube structure.

2. Description of Related Art

When two members are bonded together, an adhesive is often used. However, the bond strength is relatively low. The adhesive is prone to aging, which allows the bond to weaken such that the two members come apart easily.

Alternative stronger bonding methods are available; one such method involves using a high level of heat to bond members. This high temperature heat treatment bonding method can overheat some areas of the members and cause deformation or unwanted distortion to the members being bonded together. Therefore, improvement in the art is highly desired.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flow chart according to one embodiment of a method for bonding members.

FIG. 2 is a schematic process diagram according to one embodiment of a method for bonding members.

FIG. 3 is a Scanning Electron Microscope (SEM) image of a drawn carbon nanotube film.

FIG. 4 is an SEM image of a pressed carbon nanotube film.

FIG. 5 is an SEM image of a flocculated carbon nanotube film.

FIG. 6 is a chart showing a tensile strength of the junction between a combination force between two members and a heating time of microwaves.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

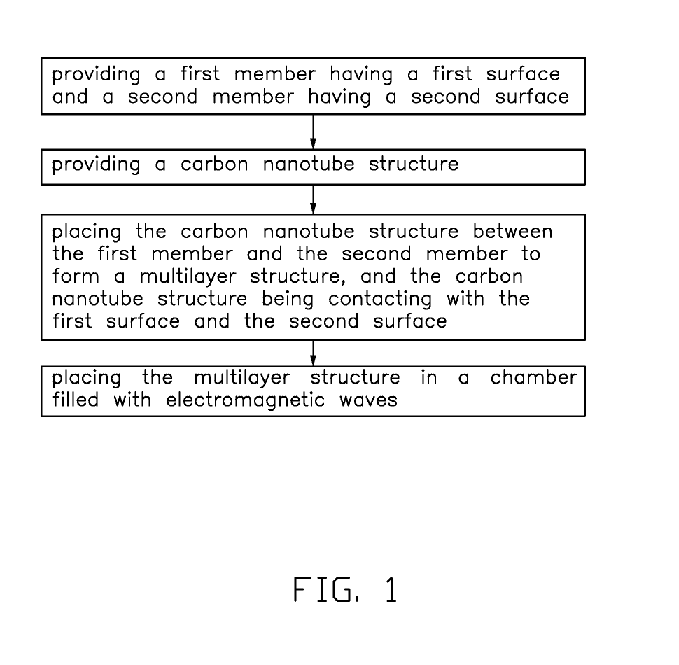

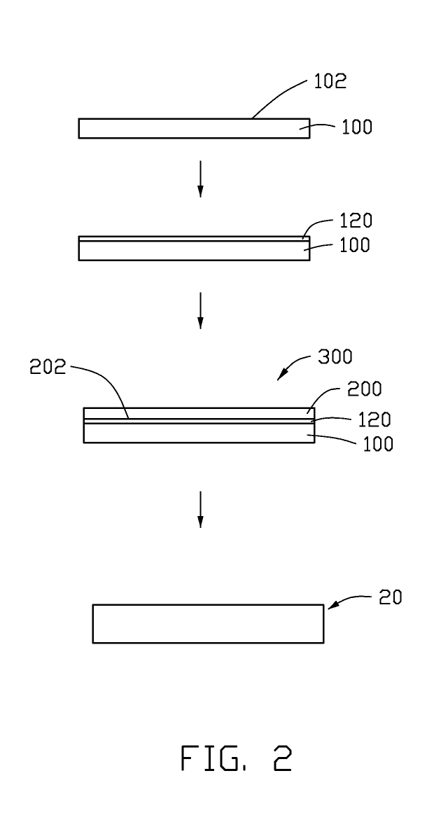

One embodiment of a method for bonding members is illustrated in FIGS. 1 and 2. The method includes following steps:

(a) providing a first member 100 and a second member 200;

(b) providing a carbon nanotube structure 120;

(c) placing the carbon nanotube structure 120 between the first member 100 and the second member 200 to form a multilayer structure 300; and

(d) placing the multilayer structure 300 in a chamber filled with electromagnetic waves.

In step (a), the first member 100 has a first surface 102, which needs to be bonded to a second surface 202 of the second member 200. The first surface 102 or the second surface 202 can be a plane surface or a curved surface. In one embodiment, the first surface 102 and the second surface 202 are both curved, and a shape of the first surface 102 corresponds with a shape of the second surface 202.

The shape of the first member 100 or the second member 200 is not limited. The first member 100 can be made of insulative materials, such as ceramic, glass, or polymeric materials. Examples of the polymeric materials comprise polyethylene, epoxide resin, bismaleimide resin, cyanate resin, polypropylene, polyethylene, polyvinyl alcohol, polystyrene enol, polycarbonate, and polymethylmethacrylate. In some embodiments, the first member 100 or the second member 200 can be parts of an apparatus or device, and the parts may be coated or may be encapsulated by insulative materials. Examples of a constituent material of the parts include polymeric materials and ceramics.

The shape and materials of the second member 200 can be the same as or different from those of the first member 100 so long as the second surface 202 can mate with the first surface 102. Examples of the shape of the second member 200 comprise a plate shape, a block shape, or a stick shape. Examples of a material of the second member 200 can be polymeric materials. Examples of the polymeric materials comprise polyethylene, epoxide resin, bismaleimide resin, cyanate resin, polypropylene, polyethylene, polyvinyl alcohol, polystyrene enol, polycarbonate, or polymethylmethacrylate.

In one embodiment, the first member 100 and the second member 200 are made of materials that have a low melting point, such as lower than 600 centidegree. Then the first member 100 and the second member 200 may be bonded together at a low temperature, and it is possible to further reduce thermal stress, which would be generated on the bonding interface. In one embodiment, the first member 100, and the second member 200 each have a plate shape. In one embodiment, the first member 100 is a cuboid having a thickness of about 9 millimeters, a length of about 3 millimeters, and a width of about 3 millimeters. The first surface 102 is a square surface having a side length of about 3 millimeters. The second member 200 has the same shape as the first member 100, and the second surface 202 is square surface having a side length of about 3 millimeters. Material of the first member 100 and the second member 200 is polyethylene.

In step (b), the carbon nanotube structure 120 includes a plurality of carbon nanotubes combined by van der Waals force therebetween. The carbon nanotube structure 120 can be a substantially pure structure of the carbon nanotubes, with few impurities. The heat capacity per unit area of the carbon nanotube structure 120 can be less than 2×10⁻⁴ J/m²*K. In one embodiment, the heat capacity per unit area of the carbon nanotube structure 120 is less than or equal to 1.7×10⁻⁶ J/m²*K. As the heat capacity of the carbon nanotube structure 120 is very low, this makes the carbon nanotube structure 120 have a high heating efficiency, a high response heating speed, and accuracy. Further, the carbon nanotubes have a low density, about 1.35 g/cm³, so the carbon nanotube structure 120 is light. The carbon nanotube structure 120 includes a plurality of micropores, and diameters of these micropores can be less than 10 micrometers. As the carbon nanotube has large specific surface area and the carbon nanotube structure includes a plurality of micropores, the carbon nanotube structure 120 with a plurality of carbon nanotubes has large specific surface area. When the specific surface of the carbon nanotube structure 120 is large enough, the carbon nanotube structure 120 is adhesive and can be directly applied to a surface. The carbon nanotube structure 120 can be adhered on the first surface 102 directly without extra adhesive material.

The carbon nanotubes in the carbon nanotube structure 120 can be orderly or disorderly arranged. The term ‘disordered carbon nanotube structure’ refers to a structure where the carbon nanotubes are arranged along different directions, and the alignment directions of the carbon nanotubes are random. The number of the carbon nanotubes arranged along each different direction can be almost the same (e.g. uniformly disordered). The disordered carbon nanotube structure can be isotropic, namely the carbon nanotube film has properties identical in all directions of the carbon nanotube film. The carbon nanotubes in the disordered carbon nanotube structure can be entangled with each other.

The carbon nanotube structure 120 can be an ordered carbon nanotube structure. The term ‘ordered carbon nanotube structure’ refers to a structure where the carbon nanotubes are arranged in a consistently systematic manner, e.g., the carbon nanotubes are arranged approximately along a same direction and/or have two or more sections within each of which the carbon nanotubes are arranged approximately along a same direction (different sections can have different directions). The carbon nanotubes in the carbon nanotube structure 120 can be selected from single-walled, double-walled, and/or multi-walled carbon nanotubes. The carbon nanotube structure 120 includes at least one carbon nanotube film. The carbon nanotube film can be a drawn carbon nanotube film, a pressed carbon nanotube film, or a flocculated carbon nanotube film.

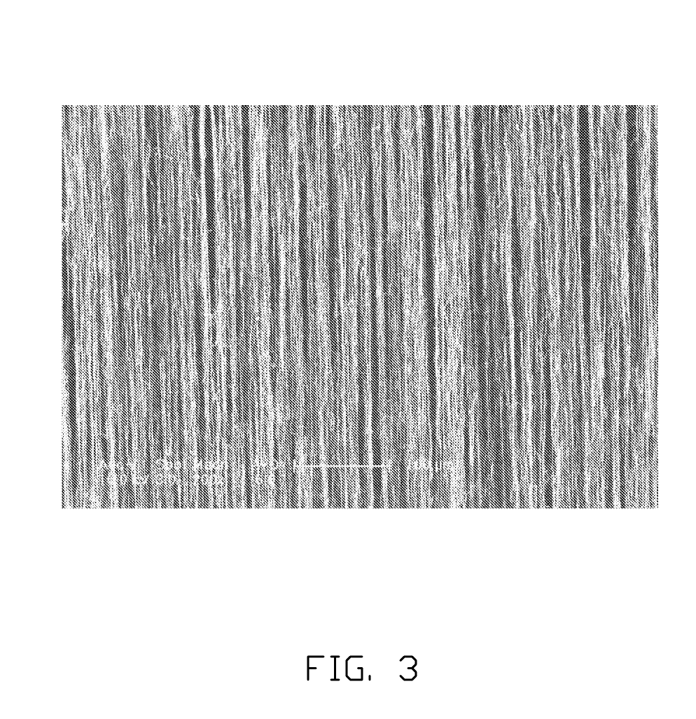

Referring to FIG. 3, the drawn carbon nanotube film includes a plurality of successive and oriented carbon nanotubes joined end-to-end by van der Waals force therebetween. The drawn carbon nanotube film is a free-standing film. A method of making a drawn carbon nanotube film includes the steps of:
Sb1: providing an array of carbon nanotubes; and
Sb2: pulling out at least a drawn carbon nanotube film from the carbon nanotube array.

In step Sb1, a method of making the array of carbon nanotubes includes:
Sb11: providing a substantially flat and smooth substrate;
Sb12: applying a catalyst layer on the substrate;
Sb13: annealing the substrate with the catalyst at a temperature in the approximate range of about 700° C. to about 900° C. in air for about 30 to about 90 minutes;
Sb14: heating the substrate with the catalyst at a temperature in the approximate range from about 500° C. to about 740° C. in a furnace with a protective gas therein; and
Sb15: supplying a carbon source gas to the furnace for about 5 to about 30 minutes and growing a super-aligned array of the carbon nanotubes from the substrate.

In step Sb11, the substrate can be a P or N-type silicon wafer. In one embodiment, a 4-inch P-type silicon wafer is used as the substrate.

In step Sb12, the catalyst can be made of iron (Fe), cobalt (Co), nickel (Ni), or any combination alloy thereof.

In step Sb14, the protective gas can be made up of at least one of nitrogen (N₂), ammonia (NH₃), and a noble gas.

In step Sb15, the carbon source gas can be a hydrocarbon gas, such as ethylene (C₂H₄), methane (CH₄), acetylene (C₂H₂), ethane (C₂H₆), or any combination thereof

In step Sb2, the drawn carbon nanotube film can be fabricated by the steps of:
Sb21: selecting one or more carbon nanotubes having a predetermined width from the array of carbon nanotubes; and
Sb22: pulling the carbon nanotubes to obtain nanotube segments at an even/uniform speed to achieve a uniform carbon nanotube film.

In step Sb21, the carbon nanotube segment includes a number of substantially parallel carbon nanotubes. The carbon nanotube segments can be selected by using an adhesive tape as the tool to contact the super-aligned array of carbon nanotubes. In step Sb22, the pulling direction can be substantially perpendicular to the growing direction of the super-aligned array of carbon nanotubes.

More specifically, during the pulling process, as the initial carbon nanotube segments are drawn out, other carbon nanotube segments are also drawn out end to end due to van der Waals force between ends of adjacent segments. This process of pulling produces a substantially continuous and uniform carbon nanotube film having a predetermined width can be obtained.

After the step of Sb2, the drawn carbon nanotube film can be treated by applying organic solvent to the drawn carbon nanotube film to soak the entire surface of the carbon nanotube film. The organic solvent is volatile and can be selected from ethanol, methanol, acetone, dichloromethane, chloroform, or any appropriate mixture thereof. In the one embodiment, the organic solvent is ethanol. After being soaked by the organic solvent, adjacent carbon nanotubes in the carbon nanotube films that are able to do so, bundle together, due to the surface tension of the organic solvent when the organic solvent is volatilizing. In another aspect, due to the decrease of the specific surface area from the bundling, the mechanical strength and toughness of the drawn carbon nanotube film are increased and the coefficient of friction of the carbon nanotube films is reduced. Macroscopically, the drawn carbon nanotube film will be an approximately uniform film.

The width of the drawn carbon nanotube film depends on the size of the carbon nanotube array. The length of the drawn carbon nanotube film can be set as desired. In one embodiment, when the substrate is a 4 inch type wafer, a width of the carbon nanotube film can be in an approximate range from 1 centimeter (cm) to 10 cm, the length of the carbon nanotube film can reach to about 120 m, the thickness of the drawn carbon nanotube film can be in an approximate range from 0.5 nm to 100 microns. Multiple films can be adhered together to obtain a film of any desired size.

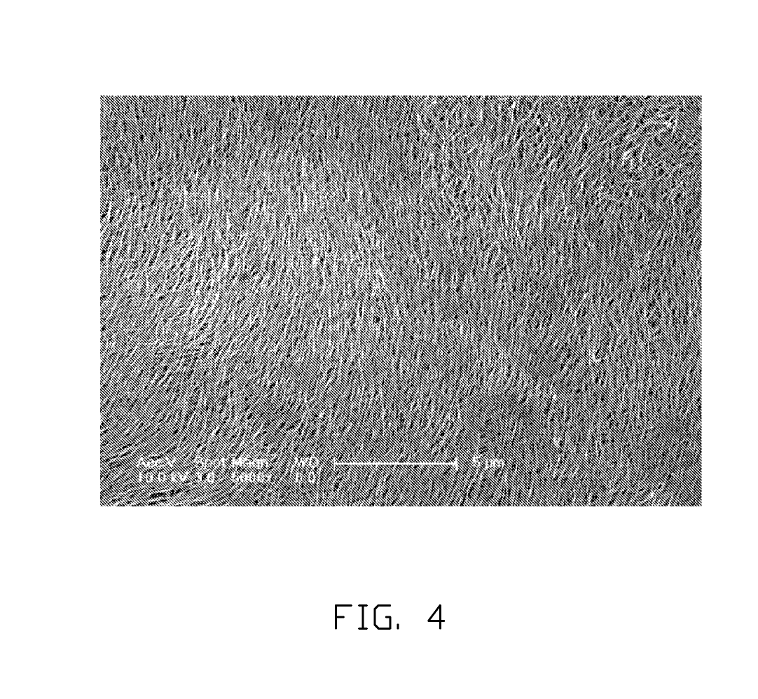

Referring to FIG. 4, the carbon nanotubes in the pressed carbon nanotube film are arranged along a same direction or along different directions. The carbon nanotubes in the pressed carbon nanotube film can rest upon each other. A method of making the pressed carbon nanotube film includes the following steps:
Sb1′: providing a carbon nanotube array and a pressing device; and
Sb2′: pressing the array of carbon nanotubes to obtain a pressed carbon nanotube film.

In step Sb1′, the carbon nanotube array can be made by the same method as Sb1.

In the step Sb2′, a certain pressure can be applied to the array of carbon nanotubes by the pressing device. In the process of pressing, the carbon nanotubes in the array of carbon nanotubes separate from the substrate and obtain the carbon nanotube film under pressure. The carbon nanotubes are substantially parallel to a surface of the carbon nanotube film.

In one embodiment, the pressing device can be a pressure head. The pressure head has a smooth surface. The shape of the pressure head and the pressing direction can determine the direction of the carbon nanotubes arranged therein. When a pressure head (e.g. a roller) is used to travel across and press the array of carbon nanotubes along a predetermined single direction, a carbon nanotube film having a number of carbon nanotubes primarily aligned along a same direction is obtained. It can be understood that there may be some variation in the film. Different alignments can be achieved by applying the roller in different directions over an array. Variations on the film can also occur when the pressure head is used to travel across and press the array of carbon nanotubes several times, variation will occur in the orientation of the nanotubes. Variations in pressure can also achieve different angles between the carbon nanotubes and the surface of the semiconducting layer on the same film. When a planar pressure head is used to press the array of carbon nanotubes along the direction perpendicular to the substrate, a carbon nanotube film having a number of carbon nanotubes isotropically arranged can be obtained. When a roller-shaped pressure head is used to press the array of carbon nanotubes along a certain direction, a carbon nanotube film having a number of carbon nanotubes aligned along the certain direction is obtained. When a roller-shaped pressure head is used to press the array of carbon nanotubes along different directions, a carbon nanotube film having a number of sections having carbon nanotubes aligned along different directions is obtained.

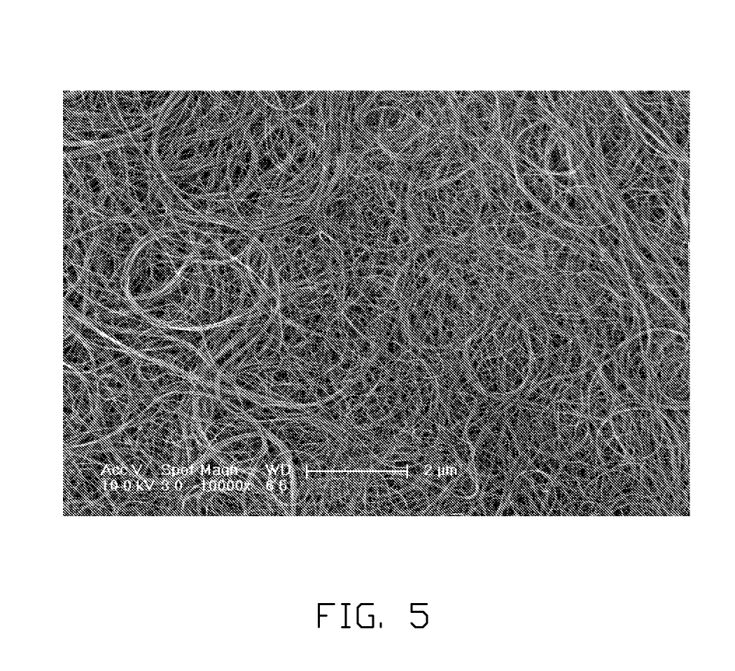

Referring to FIG. 5, the flocculated carbon nanotube film can include a plurality of long, curved, disordered carbon nanotubes entangled with each other. Furthermore, the flocculated carbon nanotube film can be isotropic. The flocculated carbon nanotube film can be made by the following method:
Sb1″: providing a carbon nanotube array;
Sb2″: separating the array of carbon nanotubes from the substrate to get a number of carbon nanotubes;
Sb3″: adding the number of carbon nanotubes to a solvent to get a carbon nanotube floccule structure in the solvent; and

Sb4″: separating the carbon nanotube floccule structure from the solvent, and shaping the separated carbon nanotube floccule structure into a carbon nanotube film to achieve a flocculated carbon nanotube film.

In step Sb1″, the carbon nanotube array can be fabricated by the same method as step Sb1.

In step Sb2″, the array of carbon nanotubes is scraped off the substrate to obtain a number of carbon nanotubes. The length of the carbon nanotubes can be above 10 microns.

In step Sb3″, the solvent can be selected from water or volatile organic solvent. After adding the number of carbon nanotubes to the solvent, a process of flocculating the carbon nanotubes can, be suitably executed to create the carbon nanotube floccule structure. The process of flocculating the carbon nanotubes can be selected from ultrasonic dispersion of the carbon nanotubes or agitating the carbon nanotubes. In one embodiment ultrasonic dispersion is used to flocculate the solvent containing the carbon nanotubes for about 10˜30 minutes. Due to the carbon nanotubes in the solvent having a large specific surface area and the tangled carbon nanotubes having a large van der Waals force, the flocculated and tangled carbon nanotubes obtain a network structure (e.g., floccule structure).

In step Sb4″, the process of separating the floccule structure from the solvent includes the sub-steps of:
Sb4″1: filtering out the solvent to obtain the carbon nanotube floccule structure; and
Sb4″2: drying the carbon nanotube floccule structure to obtain the separated carbon nanotube floccule structure.

In step Sb4″1, the carbon nanotube floccule structure can be disposed in room temperature for a period of time to dry the organic solvent therein. The time of drying can be selected according to practical needs. The carbon nanotubes in the carbon nanotube floccule structure are tangled together.

In step Sb4″2, the process of shaping includes the sub-steps of:
Sb4″21: putting the separated carbon nanotube floccule structure on a supporter (not shown), and spreading the carbon nanotube floccule structure to obtain a predetermined structure;
Sb4″22: pressing the spread carbon nanotube floccule structure with a determined pressure to yield a desirable shape; and
Sb4″23: removing the residual solvent contained in the spread floccule structure to obtain the flocculated carbon nanotube film.

Through the flocculating, the carbon nanotubes are tangled together by van der Waals force to obtain a network structure/floccule structure. Thus, the flocculated carbon nanotube film has good tensile strength.

In step (c), the carbon nanotube structure 120 is disposed between and contacts with the first surface 102 and the second surface 202.

In the step (d), a power of the electromagnetic waves can be in a range from about 200 W to about 2000 W, particularly, can be in a range from about 200 W to about 1500 W. The power of the electromagnetic wave is determined by the melting point of the materials the first member 100 and the second member 200. The higher the melting points of the materials, the higher the power of the electromagnetic wave. The electromagnetic wave can be radio wave, microwave, infrared ray or far infrared ray. A frequency of the electromagnetic waves can be in a range from about 1 GHz to about 10 GHz. In one embodiment, the electromagnetic waves are microwaves. The multilayer structure 300 is kept and heated in the chamber filled with microwaves for about 3 seconds to about 90 seconds. It is noteworthy that the time the multilayer structure 300 heated in the chamber filled with microwaves depends on the material of the first member 100 and the second member 200, and the power of the microwaves. The higher the melting points of the materials of the first and second members 100 and 200, the longer the time. The higher the power of the microwaves, the shorter the time. In one embodiment, the time is about 30 seconds.

In the step (d), the materials of the first member 100 and the second member 200 are polymer that barely absorbs energy of microwaves, so the first member 100 and the second member 200 will not be significantly heated by the microwaves themselves. The carbon nanotube structure 120 between the first member 100 and the second member 200 can absorb the energy of the microwaves and generate heat. Because the carbon nanotube structure 120 has a small heat capacity per unit area, a temperature of the carbon nanotube structure 120 raises quickly and is high, which causes the first surface 102 and the second surface 202 to melt or soften. In one embodiment, the microwaves make the carbon nanotube structure 120 raise to a high temperature, allowing the first surface 102 and the second surface 202 to be uniformly heated since the carbon nanotube structure 120 is evenly disposed between the first surface 102 and the second surface 202.

When temperatures of the first surface 102 and the second surface 202 reach to their melting points, the first surface 102 and the second surface 202 become soft or molten. During this process, the melting materials of the first surface 102 and the second surface 202 tend to permeate into and through micropores of the carbon nanotube structure 120 to opposite surfaces. As a result, the first surface 102 and the second surface 202 are bonded together.

For example, when the first member 100 and the second member 200 are made of polyethylene, which has a melting point of about 137° C., the multilayer structure 300 can be kept in the chamber filled with microwaves until the temperatures of the first surface 102 and the second surface 202 reach or get a little high than the melting point of about 137° C. Then, the first surface 102 and the second surface 202 can be bonded together.

Step (d) can be carried out in vacuum environment of about 10⁻² Pascals to about 10⁻⁶ Pascals, or in a specific atmosphere of protective gases including nitrogen gas and inert gases. The carbon nanotube structure 120 can generate a lot of heat and reach the temperature of about 2000° C. to bond members, which have high melting points when the carbon nanotube structure 120 works in vacuum environment or in a specific atmosphere.

The method further comprises another step (d) of applying pressure to the first member 100 and/or the second member 200 when the first surface 102 and the second surface 202 are in melting or softening state. In this process, the melting materials of the first surface 102 and the second surface 202 are pressed and accelerated to permeate into and go through micropores of the carbon nanotube structure 120 to opposite surfaces. As a result, the first surface 102 and the second surface 202 can be tightly and quickly bonded together. In one embodiment, a press force is applied between the first member 100 and the second member 200. The press force is about 0.5 newton (N).

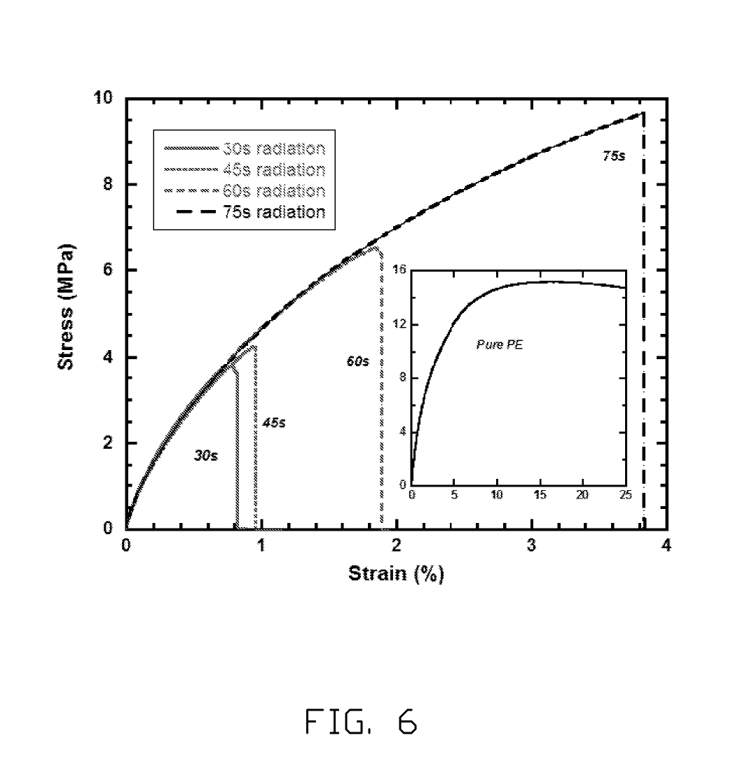

Referring to FIG. 6, a material of the first member 100 and the second member is polyethylene, the power of the microwaves is about 750 W, and the frequency of the microwaves is about 2.45 GHz. A tensile strength of the junction between the first member 100 and the second member 200 raises with the increment of the heating time with microwaves. If the time is about 75 seconds, the tensile strength between the first member 100 and the second member 200 is about 10 MPa, which is almost the same as a pure polyethylene structure.

The methods for bonding members disclosed in the present disclosure can include the following advantages. First, the thickness of the carbon nanotube structure 120 can be nanoscale, as such, no gaps will be formed at the junction between the first member 100 and the second member 200, and the first member 100 and the second member 200 can combine firmly with each other. Second, the carbon nanotube structure 120 is flexible, which will not affect flexibility of the first member 100 and the second member 200. Further, the present method for bonding members is very simple and easy to operate.

Finally, it is to be understood that the above-described embodiments are intended to illustrate rather than limit the present disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for bonding members comprising the following steps:
(a) providing a first member having a first surface, a second member having a second surface and a carbon nanotube structure;
(b) applying the carbon nanotube structure between the first member and the second member, such that the carbon nanotube structure is in contact with the first surface and the second surface; and
(c) exposing the carbon nanotube structure to electromagnetic waves.

2. The method of claim 1, wherein in step (c), the carbon nanotube structure exposed to the electromagnetic waves, such that the carbon nanotube structure will self-heat to a temperature equal to or higher than a melting temperature of the first member or the second member.

3. The method of claim 2, wherein in step (c), the carbon nanotube structure defines a plurality of micropores; and the first surface and the second surface are melted by the carbon nanotube structure, and material from the first surface and the second surface infiltrate the plurality of micropores of the carbon nanotube structure.

4. The method of claim 2, further comprising applying pressure on at least one of the first member and the second member when at least a portion of one of the first member and the second member is in melting or softened state.

5. The method of claim 1, wherein power of the electromagnetic waves is in a range from about 200 W to about 2000 W.

6. The method of claim 1, wherein the electromagnetic waves are microwaves.

7. The method of claim 1, wherein in step (d), the carbon nanotube structure, is exposed to the electromagnetic waves for about 3 seconds to about 90 seconds.

8. The method of claim 1, wherein the carbon nanotube structure comprises at least one carbon nanotube film.

9. The method of claim 8, wherein the at least one carbon nanotube film is a drawn carbon nanotube film comprising a plurality of successively oriented carbon nanotube segments joined end-to-end by van der Waals force therebetween, each carbon nanotube segment comprises a plurality of carbon nanotubes that are parallel to each other and combined by van der Waals force therebetween, and the plurality of carbon nanotubes of the at least one drawn carbon nanotube film are aligned along a same direction.

10. The method of claim 8, wherein the carbon nanotube structure comprises a plurality of stacked drawn carbon nanotube films, and the plurality of stacked drawn carbon nanotube films are fabricated according to following steps:
(1) providing an array of carbon nanotubes;
(2) pulling out a carbon nanotube film from the array of carbon nanotubes;
(3) providing a frame and adhering the carbon nanotube film to the frame;
(4) repeating steps (2) and (3), depositing each successive film on a preceding film, thereby achieving at least a two-layer carbon nanotube film; and
(5) removing the plurality of stacked drawn carbon nanotube films from the frame.

11. The method of claim 1, wherein the carbon nanotube structure is a pure structure of carbon nanotubes.

12. The method of claim 1, wherein step (d) is carried out in vacuum environment of about 10⁻² Pascals to about 10⁻⁶ Pascals or in a specific atmosphere of protective gases including nitrogen gas and inert gases.

13. The method of claim 1, wherein the first member and the second member are made of insulative materials.

14. The method of claim 1, wherein melting point of the first member and the second member is less than 600° C.

15. A method for bonding members, the method comprising the following steps:
(a) providing a first member and a second member;
(b) applying a carbon nanotube structure on the first member;
(c) placing the second member adjacent to the carbon nanotube structure; and
(d) exposing the carbon nanotube structure to microwaves.

16. The method of claim 15, wherein in step (b), a coating method or a spraying method is employed.

17. The method of claim 15, wherein step (d) is carried out in vacuum environment of about 10⁻² Pascals to about 10⁻⁶ Pascals or in a specific atmosphere of protective gases comprising and one or more inert gases.

18. The method of claim 17, further comprising applying pressure on at least one of the first member and the second member.

19. The method of claim 15, wherein in the step (d), the carbon nanotube structure defines a plurality of micropores; the first member comprises a first surface contacting with the carbon nanotube structure and the second member comprises a second surface contacting with the carbon nanotube structure, and the first surface and the second surface are melted by the carbon nanotube structure, and material from the first surface and the second surface infiltrate the plurality of micropores of the carbon nanotube structure.

20. The method of claim 15, wherein a power of the microwaves is in a range from about 200 W to about 1500 W.
